(19) United States
(12) Patent Application Publication
(10) Pub. No.: US 2020/0184546 A1
(43) Pub. Date: Jun. 11, 2020

(54) METHOD AND GUI FOR SELLER DETERMINATION OF DELIVERY LOCATION IN A COMMODITY TRADE

(71) Applicant: ABAXX TECHNOLOGIES INC., TORONTO (CA)

(72) Inventors: JOSHUA CRUMB, CHRIST CHURCH (BB); ANDREW FEDAK, CHRIST CHURCH (BB); CHRISTOPHER A. WIKLOF, EVERETT, WA (US)

(21) Appl. No.: 16/706,586

(22) Filed: Dec. 6, 2019

Related U.S. Application Data
(60) Provisional application No. 62/776,007, filed on Dec. 6, 2018.

(51) Int. Cl. G06Q 30/06; G06Q 10/08

(52) U.S. Cl. CPC G06Q 30/0641; G06Q 10/0835; G06Q 30/0637; G06Q 30/0639

(57) ABSTRACT

A computer method and graphical user interface (GUI) for seller determination of commodity delivery location includes displaying, on an electronic display of a user device, a GUI including a commodity instance object, an ownership indicator, at least one preferred commodity delivery location object, a price indication field, a projected delivery date field, and a transaction wallet indicator. A commit object is displayed via the GUI. A user commitment is received via the commit objected into a server computer. The server computer causes transacting of a commit instance onto a distributed ledger carried by a plurality of non-transitory computer readable memories. An acknowledgment of the transaction commitment from the server is received, and a transaction status is displayed in the GUI.

### CROSS-REFERENCE TO RELATED APPLICATIONS

The present application claims priority benefit from co-pending U.S. Provisional Patent Application No. 62/776,007, entitled “SYSTEM AND METHOD OF SELLER DETERMINING LOCATION IN A COMMODITY TRADE,” filed Dec. 6, 2018 (docket number 3058-006-02), which application, to the extent not inconsistent with the disclosure herein, is incorporated herein by reference.

### SUMMARY

According to an embodiment, a computer method and graphical user interface (GUI) for seller determination of commodity delivery location includes displaying, on an electronic display of a seller device, a GUI including a commodity instance object corresponding to commodity instance data, an ownership indicator corresponding to current ownership status of the commodity instance, at least one preferred commodity delivery location object, a price indication field, a projected delivery date field, and a transaction wallet indicator. The computer method and GUI includes displaying, via the GUI, a commit object; receiving a seller commitment via the commit object into a server computer as a commit instance; and causing transacting, with the server computer, the commit instance onto a distributed ledger carried by a plurality of non-transitory computer readable memories. The computer method and GUI includes receiving an acknowledgement of the transaction commitment from the server computer, and displaying, in the GUI, a transaction status in a transaction status indicator object.

According to an embodiment, a computer method includes receiving a specification of a delivery location for a commodity contract by a seller, establishing a sale price for the commodity between the seller and a counterparty, and creating a smart contract on a distributed ledger. The smart contract includes a specification for the commodity, the sale price, and the delivery location. The computer method includes receiving at least partial electronic payment from the counterparty, and crediting or transmitting a token to the counterparty representing the counterparty's interest in the commodity contract.

### BRIEF DESCRIPTION OF THE DRAWINGS

FIG. 1 is a flow chart of a computer method and graphical user interface (GUI) for seller determination of commodity delivery location, according to an embodiment.

FIG. 2 is a diagram of the GUI as described in the computer method of FIG. 1, according to an embodiment.

FIG. 3 shows a variant of the computer method of FIG. 1 where the GUI is used by a seller of the commodity to list the commodity instance for sale and delivery at the seller's preferred location(s), according to an embodiment.

FIG. 4 shows a variant of the computer method of FIG. 1 where the GUI is used by a buyer of the commodity to buy a listed commodity instance, according to an embodiment.

FIG. 5 is a flow chart of a computer method, according to an embodiment.

FIG. 6 is a block diagram of a computer system configured to administer a commodity material transaction using a distributed ledger, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

As used herein, the term “seller” will be understood to be, as indicated by context, interchangeable with “owner”, “offering party” or “user”. The “seller” will be understood to mean a user with authority to offer a commodity contract for sale, using a smart contract carried by a distributed ledger. The term “buyer” will be understood to be, as indicated by context, interchangeable with “counterparty” or “second user”. The “buyer” will be understood to mean a user with authority to purchase the commodity contract from the “seller”. The inventors contemplate that commodity contracts may be bought and sold multiple times before delivery to an ultimate user, and thus a user who is a “buyer” in a first transaction offering instance may become a “seller” in a second transaction offering instance.

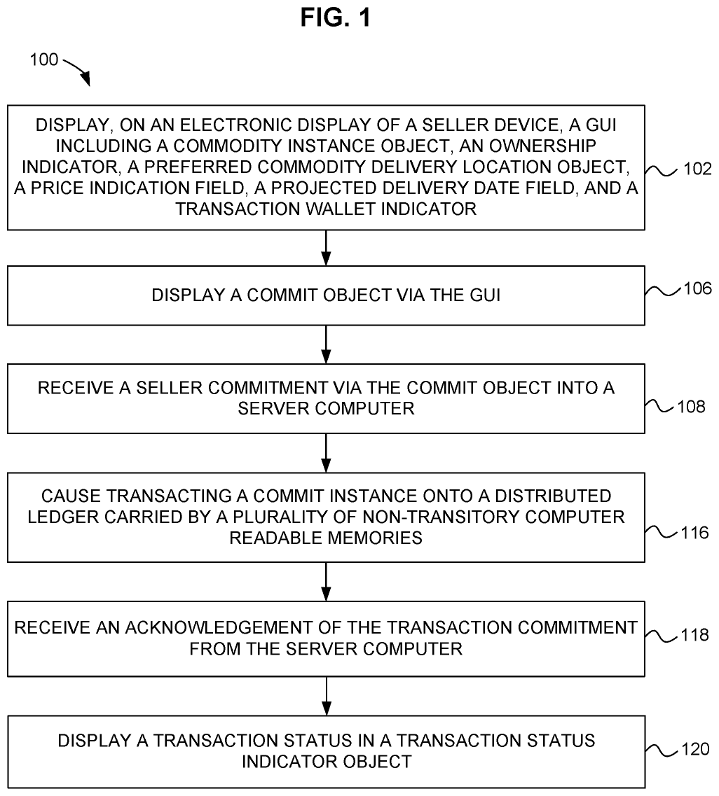

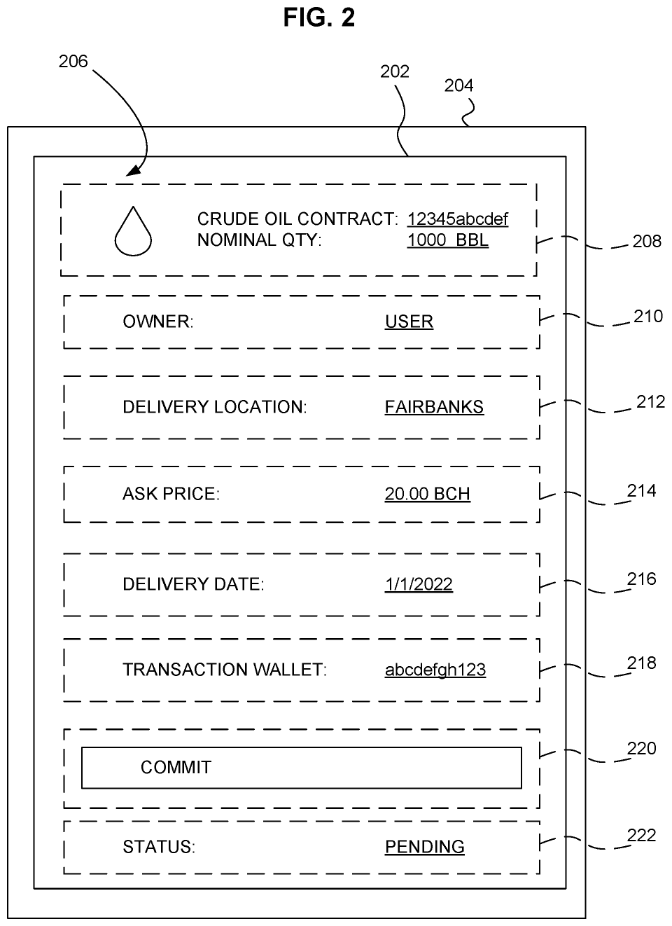

According to an embodiment, referring to FIGS. 1 and 2, a computer method 100 and graphical user interface (GUI) 206 for seller determination of commodity delivery location includes, in step 102, displaying, on an electronic display 202 of a seller device 204, a GUI 206 including a commodity instance object 208 corresponding to commodity instance data, an ownership indicator 210 corresponding to current ownership status of the commodity instance, at least one preferred commodity delivery location object 212, a price indication field 214, a projected delivery date field 216, and a transaction wallet indicator 218. Step 106 includes displaying, via the GUI 206, a commit object 220. Step 108 includes receiving a seller commitment via the commit object 220 into a server computer as a commit instance. Step 116 causing transacting, with the server computer, the commit instance onto a distributed ledger carried by a plurality of non-transitory computer readable memories. Step 118 receiving an acknowledgement of the transaction commitment from the server computer. Step 120 displaying, in the GUI 206, a transaction status in a transaction status indicator object 222.

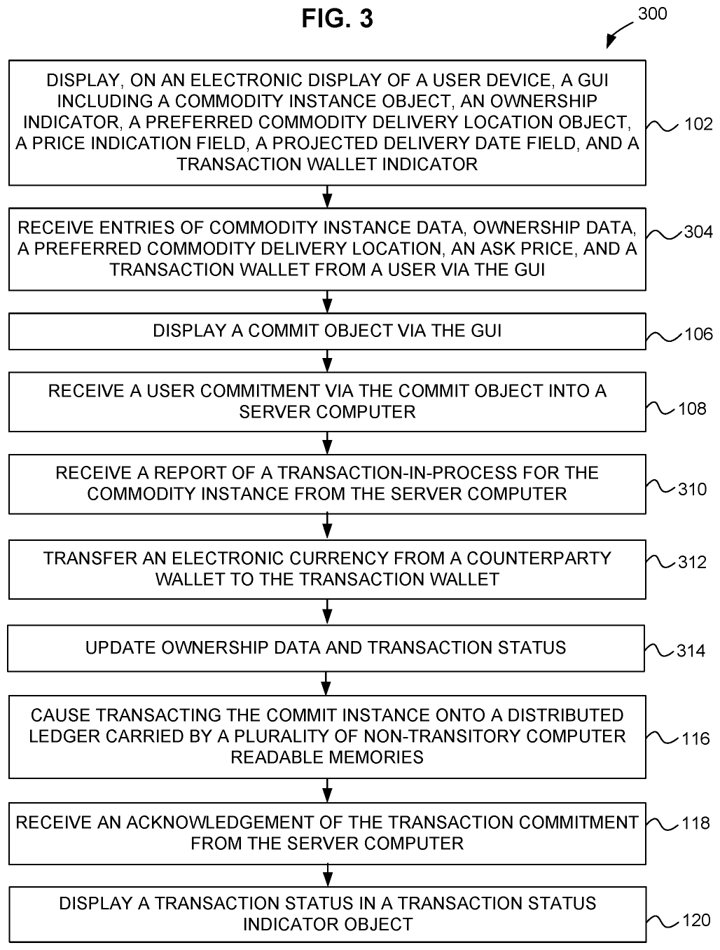

FIG. 3 shows a variant 300 of the computer method 100 of FIG. 1 where the GUI 206 is used by an owner of the commodity to list the commodity instance for sale, at the owner's preferred location(s), according to an embodiment.

According to an embodiment, referring to FIGS. 1-3, the variant 300 of the computer method 100, where the user is a seller of the commodity instance, further includes, in step 304, receiving entries of commodity instance data, ownership data, at least one preferred commodity delivery location, an ask price, and a transaction wallet address from the seller via the GUI 206 as commodity instance parameters. At least a portion of the entries may be automatically populated by the server computer from a reference user profile. In one embodiment, receiving the seller commitment via the commit object 220 into the server computer as a commit instance, in step 108, corresponds to a seller commitment to offer the commodity instance for sale according to the commodity instance parameters. In another embodiment, receiving the seller commitment via the commit object 220 into the server computer as a commit instance, in step 108, causes creating, with the server computer, a smart contract on the distributed ledger. According to an embodiment, the variant 300 of the computer 100, where the user is a counterparty as a buyer of commodity instance, further includes, in step 312, transferring, with the server computer, an electronic currency from a counterparty wallet to the transaction wallet. Step 314 includes updating ownership data in the ownership indicator 210 and updating the transaction status in the transaction status indicator object 222. In an embodiment, transferring the electronic currency from the counterparty wallet to the transaction wallet, in step 312, includes transferring a portion of the price indicated in the price indication field 214. Step 310 includes receiving a report of a transaction in-process for the commodity instance from the server computer.

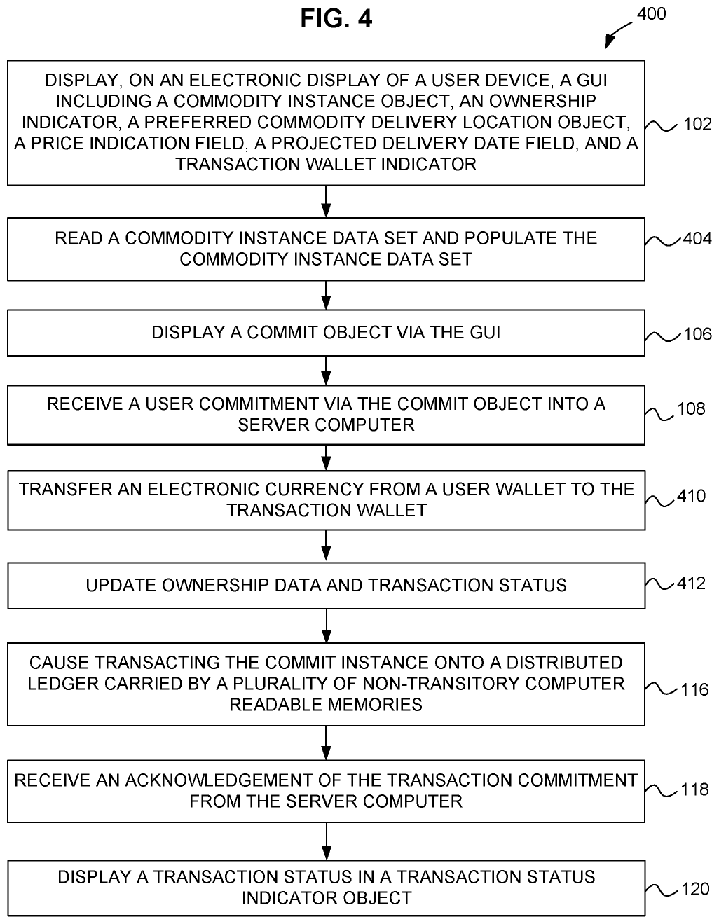

FIG. 4 shows a variant 400 of the computer method 100 of FIG. 1 where the GUI 206 is used by a buyer of the commodity to buy a listed commodity instance, according to an embodiment. For example, a shipping agent or party that contracts a shipping service may purchase a commodity from a producer at a location determined by the producer, arrange for shipment to a second location where a price is higher, and offer the commodity for sale at the second location.

According to an embodiment, referring to FIGS. 1-4, the variant 400 of the computer method 100 further includes, in step 404, reading, from the distributed ledger, a commodity instance data set and populating, on the electronic display 202 of the user device 204 in the GUI 206, the commodity instance data set in the commodity instance object 208, the ownership indicator 210, the at least one preferred commodity delivery location object 212, the price indication field 214, the projected delivery date field 216, and the transaction wallet indicator 218. In an embodiment, where the user is a counterparty acting as a buyer of the commodity instance, receiving the user commitment via the commit object 220 into the server computer as a commit instance, in step 108, corresponds to a buyer commitment to buy the commodity instance for sale according to the commodity instance parameters. In another embodiment, where the user is a counterparty acting as a buyer of the commodity instance, receiving the user commitment via the commit object 220 into the server computer as a commit instance, in step 108, causes buyer (counterparty) agreement to a smart contract on the distributed ledger. Step 410 includes transferring, with the server computer, an electronic currency from a counterparty wallet to the transaction wallet. Step 412 includes updating ownership data in the ownership indicator 210 and updating the transaction status in the transaction status indicator object 222.

According to an embodiment, referring to FIG. 1, the method 100 further includes receiving the specification of the delivery location for the commodity contract by the user. Referring to FIG. 4, the method 400 may include receiving a different proposed delivery location from a counterparty via the GUI 206, presenting the different proposed delivery location to the seller via the seller GUI, prompting the seller to indicate whether the proposed delivery location is accepted by the seller, and receiving a response from the seller. In one embodiment, receiving the response from the seller includes an indication that the seller approves the proposed delivery location. In another embodiment, receiving the response from the seller includes receiving an indication that the seller does not approve the proposed delivery location, and receiving an alternative specified delivery location from the seller.

The commodity may include a physical commodity.

According to an embodiment, the computer method 100 further includes receiving, from the user via the GUI, a specification of a delivery method for delivering the commodity to the delivery location. The smart contract may include the delivery method.

According to an embodiment, referring again to FIG. 1, transacting, with the server computer, the commit instance onto a distributed ledger carried by a plurality of non-transitory computer readable memories, in step 116, includes creating a smart contract that is carried by the distributed ledger. In an embodiment, the distributed ledger includes a blockchain. The blockchain may include at least one of a public blockchain, a private blockchain, or a permissioned blockchain. According to an embodiment, the smart contract is added to the distributed ledger as a transaction. In one embodiment, adding the smart contract to the distributed ledger includes encrypting the smart contract. In another embodiment, adding the smart contract to the distributed ledger includes storing the smart contract at one or more cloud locations, encrypting the one or more cloud locations, and entering the encrypted one or more cloud locations onto the distributed ledger as a transaction.

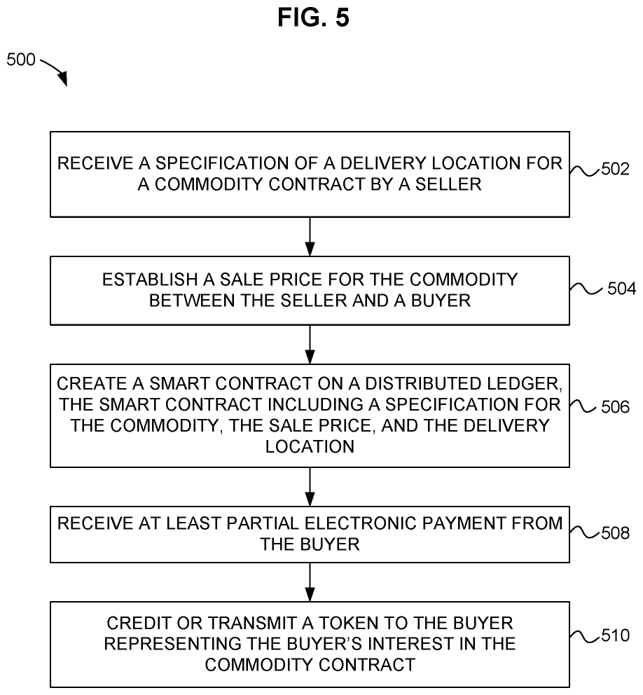

FIG. 5 is a flow chart of a computer method 500, according to an embodiment. The computer method 500 includes, in step 502, receiving, into a computer memory, a specification of a delivery location for a commodity contract by a seller. Step 504 includes establishing, with a computer processor cooperating with the computer memory, a sale price for the commodity between the seller and a buyer. Step 506 includes creating a smart contract by the computer processor on a distributed ledger, the smart contract including a specification for the commodity, the sale price, and the delivery location. Step 508 includes receiving at least partial electronic payment from the buyer, for example as a swap of electronic currency. Step 510 includes crediting or transmitting a token to the buyer representing the buyer's interest in the commodity contract. The computer method 500 includes displaying via one or more graphical user interfaces (GUIs) to the seller and the counterparty on respective electronic displays corresponding to respective electronic devices, the devices being networked to the computer, information related to the transaction defined by the computer method. Approaches to displaying the information related to the transaction are described above with respect to the GUI 206.

According to an embodiment, in step 502, receiving the specification of the delivery location for the commodity contract by the seller includes receiving the delivery location via a graphical user interface (GUI). In another embodiment, receiving the specification of the delivery location for the commodity contract by the seller includes prompting a user to provide the delivery location via the GUI and receiving a response. In another embodiment, receiving the specification of the delivery location for the commodity contract by the seller includes prompting the user to provide the delivery location and receiving a response. In another embodiment, receiving the specification of the delivery location for the commodity contract by the seller includes prompting the user with a proposed delivery location and receiving a response.

According to an embodiment, in step 506, the smart contract includes a specification for the commodity, the sale price, and the delivery location.

According to an embodiment, in step 502, receiving the specification of the delivery location for the commodity contract by the seller includes reading a default delivery location from a seller profile. In another embodiment, receiving the specification of the delivery location for the commodity contract by the seller includes receiving a proposed delivery location from the buyer, presenting the proposed delivery location to the seller, prompting the seller to indicate whether the proposed delivery location is accepted by the seller, and receiving a response from the seller. In an embodiment, receiving the response from the seller includes an indication that the seller approves the proposed delivery location. Additionally and/or alternatively, receiving the response from the seller includes receiving an indication that the seller does not approve the proposed delivery location, and receiving a specified delivery location from the seller.

According to an embodiment, the commodity includes a physical commodity.

According to an embodiment, the computer method 500 further includes receiving from the buyer a specification of a delivery method for delivering the commodity to the delivery location. In one embodiment, the smart contract includes the delivery method.

According to an embodiment, in step 508, receiving at least partial electronic payment from the buyer includes receiving a distributed ledger source address, an amount transferred, and a transfer history or transfer histories of the amount transferred. In one embodiment, receiving at least partial electronic payment from the buyer for a future delivery of the commodity at a nominal price according to the smart contract includes receiving at least the partial electronic payment for the future delivery of the commodity at the price according to the smart contract.

According to an embodiment, in step 506, the smart contract is carried by the distributed ledger carried by a plurality of non-transitory computer readable media. In an embodiment, the distributed ledger includes a blockchain. In one embodiment, the blockchain includes a public blockchain. In another embodiment, the blockchain includes a private blockchain. Additionally and/or alternatively, the blockchain includes a permissioned blockchain. According to an embodiment, the smart contract is added to the distributed ledger as a transaction. In an embodiment, adding the smart contract to the distributed ledger includes encrypting the smart contract. Additionally and/or alternatively, adding the smart contract to the distributed ledger includes storing the smart contract at one or more cloud locations, encrypting the one or more cloud locations, and entering the encrypted one or more cloud locations onto the distributed ledger as a transaction.

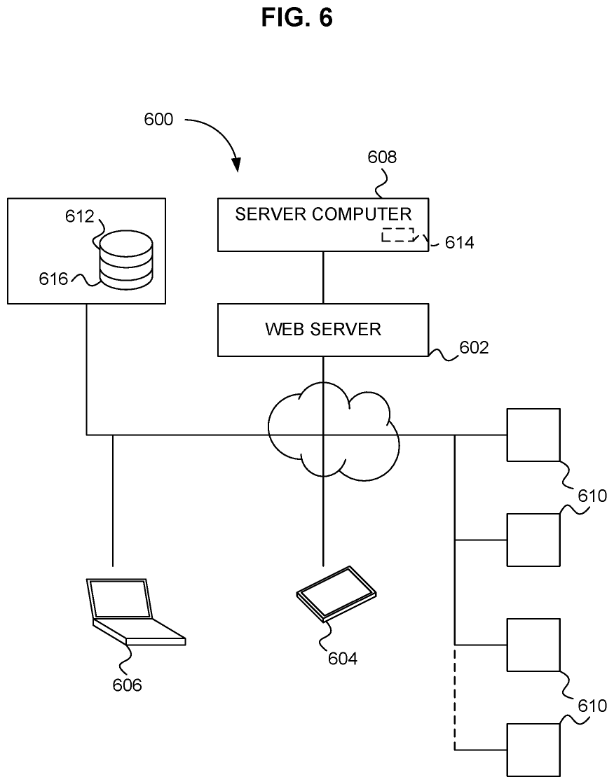

FIG. 6 is a block diagram of a computer system 600 configured to administer a commodity material transaction using a distributed ledger, according to an embodiment. As used herein, the term distributed ledger will be understood to include blockchains of various ilks. Illustrated elements described in conjunction with this figure may be described elsewhere herein and may bear dissimilar reference numbers. Corresponding elements will be understood as equivalent as indicated by context.

According to an embodiment, the computer system 600 may include a web server 602 configured to output a first GUI to a first device 604 for a party to receive and display information related to a commodity material transaction smart contract, according to an embodiment. The web server 602 may be further configured to output a second GUI to a second device 606 for a counterparty to receive and display information related to a commodity material transaction smart contract, according to an embodiment. The computer system 600 may include a server computer 608, operatively coupled to the web server 602, and configured to execute data transfer and distributed ledger transactions. The server computer 608 may be further configured to transmit display data to and receive user input from the web server 602, for relay to and from the first and second devices 604, 606.

According to an embodiment, the computer system 600 may include a plurality of devices 610 operatively coupled to the web server 602 and carrying the distributed ledger. The web server 602 may be configured to transmit the distributed ledger transactions to the plurality of devices 610, according to an embodiment. The plurality of devices 610 may be configured to collectively validate the distributed ledger transactions, according to an embodiment. The web server 602 may be configured to receive and forward collective validation to the server computer 608, according to an embodiment.

According to an embodiment, the server computer 608 may be further configured to transfer a first cryptocurrency and/or digital security associated with commodity transactions corresponding to transactions between a counterparty wallet 612 and a transaction wallet 614 via the web server 602. The server computer 608 may issue a distributed ledger token corresponding to one or more commodity material transactions, according to an embodiment.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A computer method and graphical user interface (GUI) for seller determination of commodity delivery location, comprising:
displaying, on an electronic display of a seller device, a GUI including a commodity instance object corresponding to commodity instance data, an ownership indicator corresponding to current ownership status of the commodity instance, at least one preferred commodity delivery location object, a price indication field, a projected delivery date field, and a transaction wallet indicator;
displaying, via the GUI, a commit object;
receiving a seller commitment via the commit object into a server computer as a commit instance;
causing transacting, with the server computer, the commit instance onto a distributed ledger carried by a plurality of non-transitory computer readable memories;
receiving an acknowledgement of the transaction commitment from the server computer; and
displaying, in the GUI, a transaction status in a transaction status indicator object.

2. The computer method and GUI for seller determination of commodity delivery location of claim 1, wherein the user is a seller of the commodity instance; and
further comprising:
receiving entries of commodity instance data, ownership data, at least one preferred commodity delivery location, an ask price, and a transaction wallet address from the seller via the GUI as commodity instance parameters.

3. The computer method and GUI for seller determination of commodity delivery location of claim 2, wherein at least a portion of the entries are automatically populated by the server computer from a reference seller profile.

4. The computer method and GUI for seller determination of commodity delivery location of claim 2, wherein receiving the seller commitment via the commit object into the server computer as a commit instance corresponds to a seller commitment to offer the commodity instance for sale according to the commodity instance parameters.

5. The computer method and GUI for seller determination of commodity delivery location of claim 2, wherein receiving the seller commitment via the commit object into the server computer as a commit instance causes creating, with the server computer, a smart contract on the distributed ledger.

6. The computer method and GUI for seller determination of commodity delivery location of claim 1, wherein the user is a counterparty acting as a buyer of the commodity instance; and
further comprising:
transferring, with the server computer, an electronic currency from a counterparty wallet to the transaction wallet; and
updating ownership data in the ownership indicator and updating the transaction status in the transaction status indicator object.

7. The computer method and GUI for seller determination of commodity delivery location of claim 6, wherein transferring the electronic currency from the counterparty wallet to the transaction wallet includes transferring a portion of the price indicated in the price indication field.

8. The computer method and GUI for seller determination of commodity delivery location of claim 6, further comprising:
receiving a report of a transaction in-process for the commodity instance from the server computer;

9. The computer method and GUI for seller determination of commodity delivery location of claim 1, further comprising:
reading, from the distributed ledger, a commodity instance data set and populating, on the electronic display of the user device in the GUI, the commodity instance data set in the commodity instance object, the ownership indicator, the at least one preferred commodity delivery location object, the price indication field, the projected delivery date field, and the transaction wallet indicator.

10. The computer method and GUI for seller determination of commodity delivery location of claim 9, wherein the user is a counterparty acting as a buyer of the commodity instance; and
wherein receiving the user commitment via the commit object into the server computer as a commit instance corresponds to a user commitment to buy the commodity instance for sale according to the commodity instance parameters.

11. The computer method and GUI for seller determination of commodity delivery location of claim 9, wherein the user is a counterparty acting as a buyer of the commodity instance; and
wherein receiving the user commitment via the commit object into the server computer as a commit instance causes counterparty agreement to a smart contract on the distributed ledger.

12. The computer method and GUI for seller determination of commodity delivery location of claim 9, further comprising:
transferring, with the server computer, an electronic currency from a counterparty wallet to the transaction wallet; and
updating ownership data in the ownership indicator and updating the transaction status in the transaction status indicator object.

13. The computer method and GUI for seller determination of commodity delivery location of claim 1, further comprising:
receiving the specification of the delivery location for the commodity contract by the seller, via the GUI; and
further comprising:
receiving a different proposed delivery location from a counterparty;
presenting the different proposed delivery location to the seller via the seller GUI;
prompting the seller to indicate whether the proposed delivery location is accepted by the seller; and
receiving a response from the seller.

14. The computer method and GUI for seller determination of commodity delivery location of claim 13, wherein receiving the response from the seller includes an indication that the seller approves the proposed delivery location.

15. The computer method and GUI for seller determination of commodity delivery location of claim 13, wherein receiving the response from the seller includes:
receiving an indication that the seller does not approve the proposed delivery location; and
receiving an alternative specified delivery location from the seller.

16. The computer method and GUI for seller determination of commodity delivery location of claim 1, wherein the commodity includes a physical commodity.

17. The computer method and GUI for seller determination of commodity delivery location of claim 1, further comprising receiving, from the user via the GUI, a specification of a delivery method for delivering the commodity to the delivery location.

18. The computer method and GUI for seller determination of commodity delivery location of claim 17, wherein the smart contract includes the delivery method.

19. The computer method and GUI for seller determination of commodity delivery location of claim 1, transacting, with the server computer, the commit instance onto a distributed ledger carried by a plurality of non-transitory computer readable memories includes creating a smart contract is carried by the distributed ledger.

20. The computer method and GUI for seller determination of commodity delivery location of claim 19, wherein the distributed ledger comprises a blockchain.

21. The computer method and GUI for seller determination of commodity delivery location of claim 20, wherein the blockchain comprises a public blockchain.

22. The computer method and GUI for seller determination of commodity delivery location of claim 20, wherein the blockchain comprises a private blockchain.

23. The computer method and GUI for seller determination of commodity delivery location of claim 20, wherein the blockchain comprises a permissioned blockchain.

24. The computer method and GUI for seller determination of commodity delivery location of claim 19, wherein the smart contract is added to the distributed ledger as a transaction.

25. The computer method and GUI for seller determination of commodity delivery location of claim 24, wherein adding the smart contract to the distributed ledger comprises encrypting the smart contract.

26. The computer method and GUI for seller determination of commodity delivery location of claim 24, wherein adding the smart contract to the distributed ledger comprises:
storing the smart contract at one or more cloud locations;
encrypting the one or more cloud locations; and
entering the encrypted one or more cloud locations onto the distributed ledger as a transaction.

27. A computer method, comprising:
receiving, into a computer memory, a specification of a delivery location for a commodity contract by a seller;
establishing, with a computer processor cooperating with the computer memory, a sale price for the commodity between the seller and a counterparty;
creating, by the computer processor, a smart contract on a distributed ledger, the smart contract including a specification for the commodity, the sale price, and the delivery location;
receiving at least partial electronic payment from the counterparty;
crediting or transmitting a token to the counterparty representing the counterparty's interest in the commodity contract; and
displaying via one or more graphical user interfaces (GUIs), to the seller and the counterparty on respective electronic displays corresponding to respective electronic devices, the devices being networked to the computer, information related to the transaction defined by the computer method.

28. The computer method of claim 27, wherein receiving the specification of the delivery location for the commodity contract by the seller includes receiving the delivery location via a graphical user interface (GUI).

29. The computer method of claim 28, wherein receiving a specification of the delivery location for the commodity contract by the seller includes prompting a user to provide the delivery location via the GUI and receiving a response.

30. The computer method of claim 27, wherein receiving the specification of the delivery location for the commodity contract by the seller includes prompting a user to provide the delivery location and receiving a response.

31. The computer method of claim 30, wherein receiving the specification of the delivery location for the commodity contract by the seller includes prompting the user with a proposed delivery location and receiving a response.

32. The computer method of claim 27, wherein the smart contract includes a specification for the commodity, the sale price, and the delivery location.

33. The computer method of claim 27, wherein receiving the specification of the delivery location for the commodity contract by the seller includes reading a default delivery location from a seller profile.

34. The computer method of claim 27, wherein receiving the specification of the delivery location for the commodity contract by the seller includes:
receiving a proposed delivery location from the buyer;
presenting the proposed delivery location to the seller;
prompting the seller to indicate whether the proposed delivery location is accepted by the seller; and
receiving a response from the seller.

35. The computer method of claim 34, wherein receiving the response from the seller includes an indication that the seller approves the proposed delivery location.

36. The computer method of claim 34, wherein receiving the response from the seller includes:
receiving an indication that the seller does not approve the proposed delivery location; and
receiving a specified delivery location from the seller.

37. The computer method of claim 27, wherein the commodity includes a physical commodity.

38. The computer method of claim 27, further comprising receiving from the buyer a specification of a delivery method for delivering the commodity to the delivery location.

39. The computer method of claim 38, wherein the smart contract includes the delivery method.

40. The computer method of claim 27, wherein receiving at least partial electronic payment from the buyer includes receiving a distributed ledger source address, an amount transferred, and a transfer history or transfer histories of the amount transferred.

41. The computer method of claim 27, wherein receiving at least partial electronic payment from the buyer for a future delivery of the commodity at a nominal price according to the smart contract includes:
receiving at least the partial electronic payment for the future delivery of the commodity at the price according to the smart contract.

42. The computer method of claim 27, wherein the smart contract is carried by the distributed ledger carried by a plurality of non-transitory computer readable media.

43. The computer method of claim 42, wherein the distributed ledger comprises a blockchain.

44. The computer method of claim 43, wherein the blockchain comprises a public blockchain.

45. The computer method of claim 43, wherein the blockchain comprises a private blockchain.

46. The computer method of claim 43, wherein the blockchain comprises a permissioned blockchain.

47. The computer method of claim 42, wherein the smart contract is added to the distributed ledger as a transaction.

48. The computer method of claim 47, wherein adding the smart contract to the distributed ledger comprises encrypting the smart contract.

49. The computer method of claim 47, wherein adding the smart contract to the distributed ledger comprises:
storing the smart contract at one or more cloud locations;
encrypting the one or more cloud locations; and
entering the encrypted one or more cloud locations onto the distributed ledger as a transaction.
